(19) United States
(12) Patent Application Publication
(10) Pub. No.: US 2005/0126897 A1
(43) Pub. Date: Jun. 16, 2005

(54) Reconfigurable switch

(75) Inventor: Christopher Stephens, Box Hill North Victoria (AU)

Correspondence Address: CONNOLLY BOVE LODGE & HUTZ LLP, SUITE 800, 1990 M STREET NW, WASHINGTON, DC, 20036-3425, US

(73) Assignee: Platysys Pty Ltd., Victoria (AU)

(21) Appl. No.: 10/509,305

(22) PCT Filed: Mar. 27, 2003
(86) PCT No.: PCT/AU03/00367

(30) Foreign Application Priority Data
Mar. 28, 2002 (AU) PS 1381

(51) Int. Cl. H01H 9/00

(52) U.S. Cl. 200/5 A

(57) ABSTRACT

To simplify the reconfiguration of switches in a building automation switch panel, touch switches (27) of the mechanical, capacitive or charge transfer type are configured so that the electrode pattern (25) on the switch body can be activated using switch positions on a cover plate (27). The electrode pattern on the reverse face of the cover plate are selected so that a set of cover plates in combination with a single switch body provides as many switch positions as the body can provide. This makes reconfiguring, a matter of changing the front cover plate of the switch and using a software program to reconfigure the electronics if necessary.

This invention relates to a switch panel of the type used in networked control systems of the type typically used in building automation.

### BACKGROUND TO THE INVENTION

In Building automation switch panels may carry a multiple of switches which can be configured to actuate a range of appliances from lights, alarm systems, washing machines, cooking appliances, air conditioners etc. Buildings are initially fitted out with a network and switch nodes which are usually later customized during commissioning to suit the particular requirements of each location within the building. This means that when tenants or owners move in, the network is customized to the tenant preferences by changing the functions and sometimes the number of switches at points within the building, such changes being typically made by replacement or modification of the existing switches. Sometimes the configurations need to be changed to accommodate additional or relocated appliances. Thus it is often necessary to increase or decrease the number of active switches on a panel. Conventionally this is done by replacing the switch and its associated integrated control circuit and reconfiguring the software that operates the system.

Even in the case of standard electrical switches, such as common light switches, where no software control system is employed it is sometimes necessary to modify existing installations to operate in a different manner. For example, a switch plate may have three independent switching means to operate three independent light sources and it may be desirable to change this so that a single switch may operate all three light sources simultaneously. In such a case the conventional approach to this change would be to change the switch panel containing the three independent switches to a single switch unit panel.

It is an object of this invention to provide a more convenient arrangement to facilitate changes to existing switch and control arrangements.

### BRIEF DESCRIPTION OF THE INVENTION

To this end the present invention provides an automation system for programming appliances having two or more switch units capable of carrying a switch array to control specified appliances, each switch array having a switch cover with actuation icons corresponding to the appliances to be controlled and switch enabling means that only activate the switches corresponding to the actuation icons on said switch cover in which the appliances to be controlled from a switch unit may be varied by changing the switch cover.

Throughout this specification automation system refers to any switch controllable system for controlling appliances lighting and the like within a building, factory or residence.

By locating an active or enabling portion of each switch on the cover only selected switches on the switch array are enabled which allows the appliances controlled by any switch unit to be varied by simply changing the switch cover. Using such a system each switch unit can be capable of operating every appliance in the system or subsystem but only enabled for those appliances indicated by icon on the switch cover.

In another aspect this invention provides a panel switch which includes
a) a fixed unit, capable of carrying a multiple n of active switches
b) a replaceable cover adapted to be attached to the fixed unit and able to carry up to n active contact closure positions
c) wherein the covers only carry as many active positions as is desired so that the number of active switches on a fixed unit and the number of actuation positions can be changed by changing the cover.

This invention provides the advantage that one basic fixed switch unit usually mounted on a wall incorporating an integrated control circuit having n switches can be used with replaceable covers having any desired number of active switches from one up to n.

Throughout this specification contact closure means a device that when placed in an activation position adjacent a switch body is able to actuate mechanically or electronically to power up or turn off an appliance. This may be a mechanical closure such as a toggle or a tactile switch in which pressure allows contact to be made in a signal circuit. It may also be a touch switch in which the touch or proximity of a finger actuates a signal. The contact closure may comprise one contact position and one switch closure position or a single contact position may operate a multiple of closures to send a multiple of signals.

Throughout this specification the term cover includes a cover plate, label, polycarbonate membrane switch or other member capable of carrying one or more contact closures. The cover is preferably capable of accurate registration over the fixed unit so that the closure positions on the cover will correspond with the closure positions on the fixed unit. The cover plate defines the number of switches, the style of switch and the functionality of the switch unit. The switch system has no function until a cover plate is placed over the switch mechanism. The cover plate defines by way of the patterns on its reverse side the functional operation of the switch unit. The patterns on the reverse side engage or activate complementary patterns on the switch unit which determine how the associated electronics and the connected appliances will operate. With tactile switches the back of the cover carries plastic or metallic actuators that either allow pressure actuation of the complementary portion of the switch in the switch unit or permanently engage the switch or allow no contact so that the actuators behind the icons on the front cover act as switches and the other positions are either permanently on or off.

Preferably the switches are touch or proximity switches of the capacitive or charge transfer type and one of a pair of electrodes for each switch is carried on the fixed unit and one on the cover. The limitation on the functions is limited to the practical size of the switch and the finger size to press a switch.

Combinations of switches can be used. The fixed unit may carry a matrix of 32 electrodes which appears to be an optimum size for a standard switch plate. 32 inputs allows 1024 possible cover plate options. Some of these may be reserved for cover plate identification. Due to practical size considerations, the preferred number of active switch units on the cover is six but this number is not limited to six. For example in the case of a six switch fixed unit a cover plate having just a single switch unit when positioned over the fixed unit would be so arranged that the operation or touch, in the case of a touch control interface, on the single switch means on the cover plate would simultaneously operate all of the switches on the fixed unit. In the case of this example the multiple switch fixed unit would have been thus adapted to a single switch unit by the addition of just the cover plate. The change of cover plate to effect the change in operation of the fixed unit from a six to a one switch unit removes the need for a skilled technician being required to make physical changes to the fixed unit and to reprogram the system software to accommodate any change to the wiring of the fixed unit.

In a further aspect this invention provides a panel switch which includes
a) an electronic control circuit and an associated switch array for capacitative or charge transfer switches
b) a control array bearing electrodes to complete a predetermined number of said switches on said switch array
c) said control array being associated with a cover member carrying on its face surface icon indicia corresponding to the switches to be actuated from the panel switch.

In some circumstances, such as for the visually impaired, tactile switches are preferred to touch switches so that the user can sense that the contact closure device has been actuated.

Any suitable touch or proximity switch which uses capacitance or charge transfer between an electrode or component on the cover plate and a complementary electrode on the switch body may be used.

The cover plates can be made in any suitable material. If the matrix of electrodes is printed onto a suitable sheet this may be bonded to the rear of any suitable material such as glass, plaster board, plastic, wood, copper, aluminium, brass or ceramic tiles. Ferro magnetic materials are not suitable. The front surface will carry indicia corresponding to the function of the switch electrode on the rear of the cover.

Thus the number of cover plates needed to provide a full range of switch combinations is equal to the maximum number of switches provided on the fixed switch unit. When the switch cover plate is changed, it may be also necessary in some cases to reprogram the system software to link an appliance to the additional switches or alternatively to delete or reassign the appliance when the number of switches is reduced. For example a simple change from one switch to two switches can be achieved by a simple cover change but a a complex change as from on off for a light to a dimming switch may require logic changes or software updates to the switch unit. The reprogramming may be achieved using any of the available software programs. Some appliances are programmed to search for a switch. Alternately software of the kind described in U.S. Pat. No. 5,530,896 may be used to assign an address for the appliance. The reconfiguration can also be made by a technician using a lap top computer connected to the switch body's integrated circuit. There are also graphic software programs which can be used on the household computer to reconfigure the integrated circuit. Alternately the software in the system may incorporate the capacity to change configurations and this may be activated by the system identifying the cover by way of an identification number for each cover configuration. Such software can be updated by simply installing an update program at the time of changing the cover.

Another benefit of this invention in the case of some applications is that of redundancy. For example if a fixed unit has six switches each connected independently to a separate light source and it is desired to change the system so that only a single switch many operate all lights sources simultaneously then the system software may be changed so that any of the six switches may operate all lights. In the case that any particular switch becomes inoperable due to a failure then the user still may operate all light by switching any of the other five switches that are still functioning. However, if the six switch fixed unit is modified to a single switch unit by changing the cover plate and if operation of the single switch unit on the cover plate operates each and all of the six corresponding switches on the fixed unit then it does not matter if one or even up to five of the fixed units switched were to fail as the operation of the cover plate switch would still also operate the remaining functioning fixed unit switch.

### DETAILED DESCRIPTION OF THE INVENTION

A preferred embodiment of the invention is described with reference to the drawings in which:

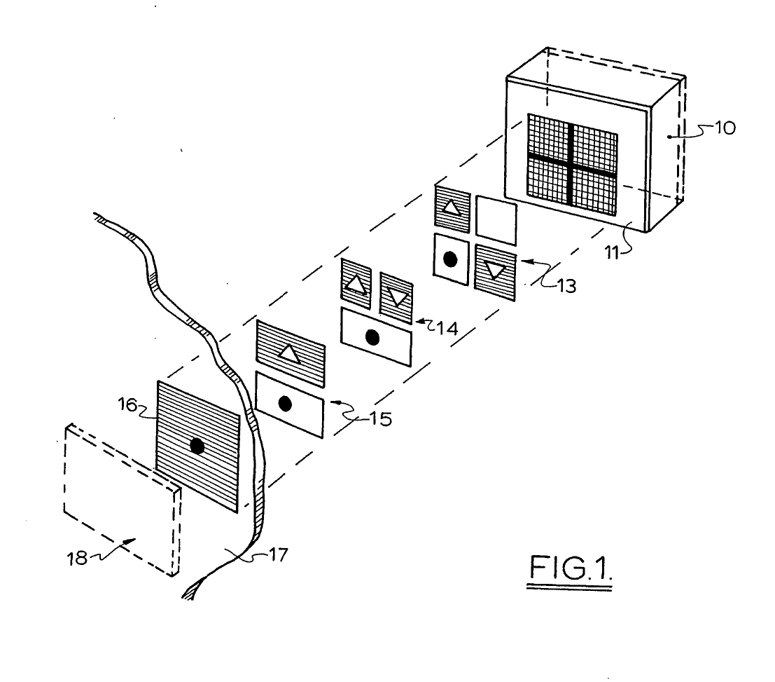

FIG. 1 is a schematic conceptual view of the invention;

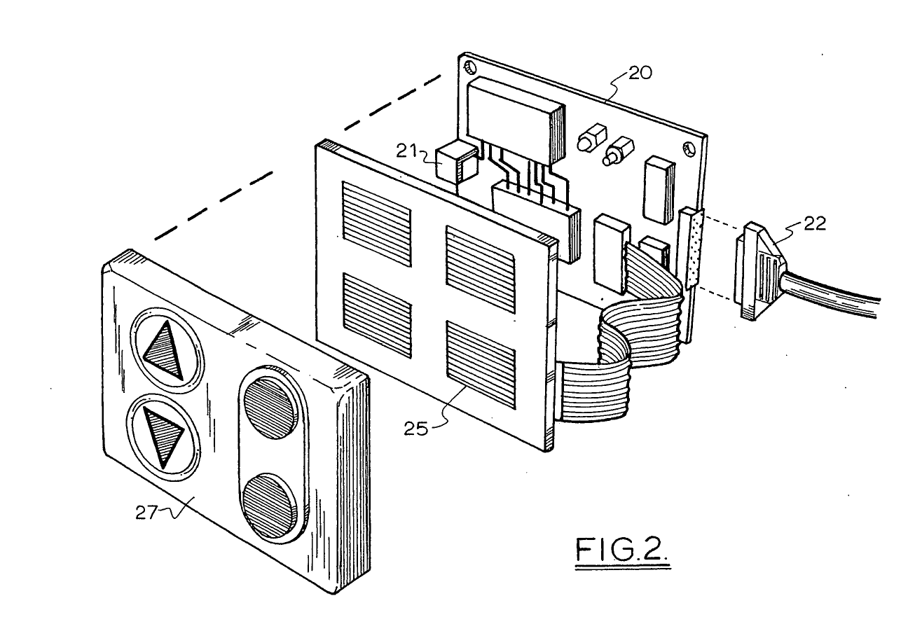

FIG. 2 is a schematic view of a 4 switch cover plate and control panel of this invention;

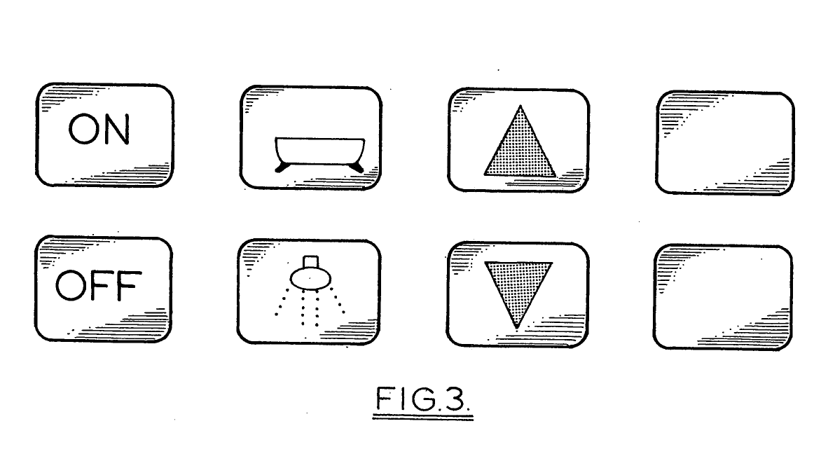

FIG. 3 is a sample of the indicia which may be used on the surface of a ceramic cover plate intended for a bathroom;

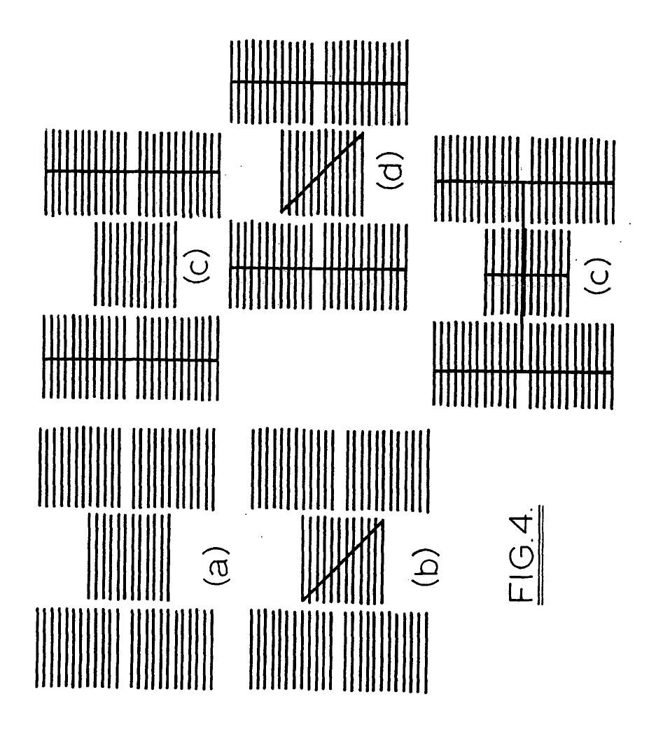

FIG. 4 shows 5 interdigitated electrode arrays that can be printed on the back of a control panel cover;

FIG. 5 is a view of the front surface of a switch panel having 4 switches to be used with the array of FIG. 4;

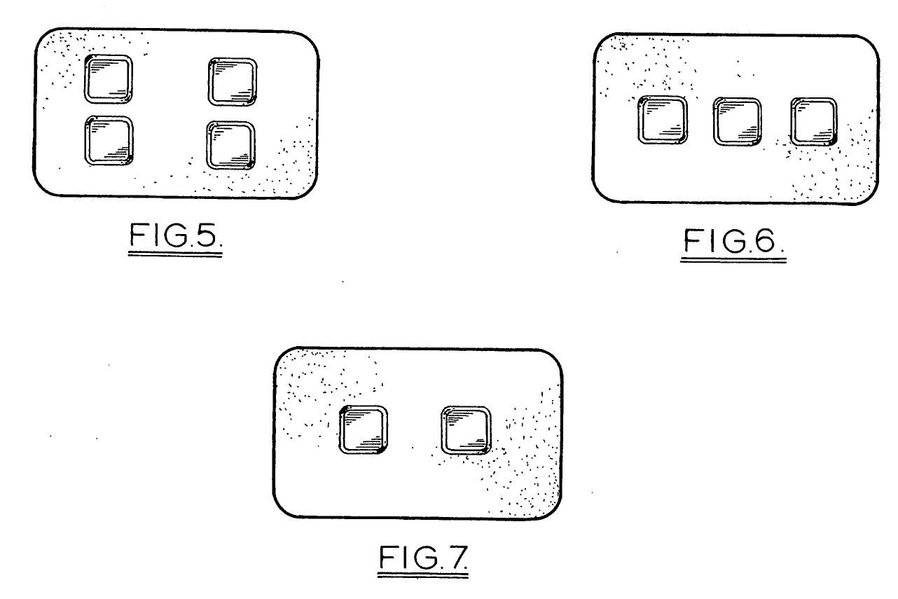

FIG. 6 is a view of the front surface of a switch panel having 3 switches to be used with the array of FIG. 4;

FIG. 7 is a view of the front surface of a switch panel having 2 switches to be used with the array of FIG. 4;

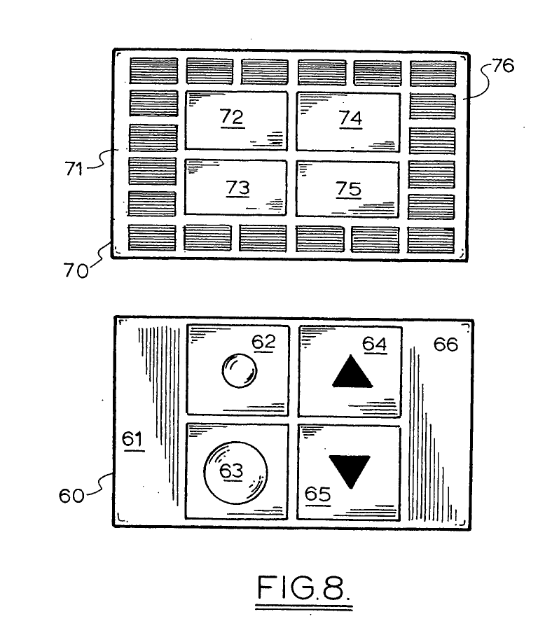

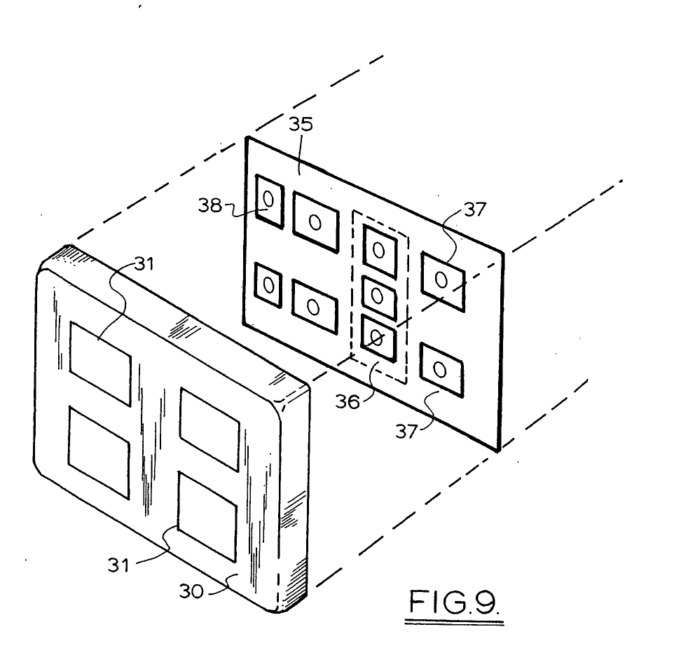

FIG. 8 is a schematic view of a gesture switch in accordance with this invention;

FIG. 9 is a schematic view of a tactile switch unit of this invention;

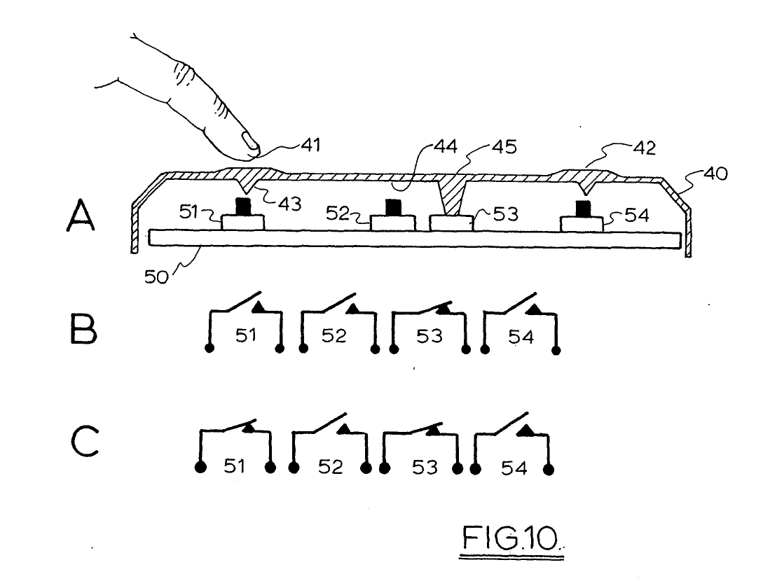

FIGS. 10A, B and C is a sectional schematic view of the tactile switch of FIG. 9.

The switch panels of this embodiment use charge transfer switch arrays of the kind marketed by Quantum Research Group as Q Matrix™ and one example is the QT60040 matrix for touch control keys. These are used in appliances or in building automation applications where each switch position activates an appliance. These may be used in a network such as LonWorks™ networks.

As shown in FIG. 1 the unit consists of a fixed control unit 10 having electronic circuitry and a switch array layer 11. This switch array is completed by a matching control surface which may be configured in any combination. For simplicity a 4 switch array 11 is shown with 4 possible control surface configurations 13, 14, 15 and 16. These control surfaces are fixed to the rear of a wall plate 18 made of any suitable material. The wall plate may carry indicia matching the function of the switch. The wall plate may be placed over any substrate 17 that is used as a building material such as glass plasterboard, wood tiles or non magnetic metals or alloys. Alternatively the control surface may be placed on the substrate and the cover plate mounted accordingly.

FIG. 2 illustrates a more specific embodiment of a 4 switch array. The control circuit 20 is connected to a power supply 21 and sends control signals to the devices under its control by serial cable 22.

The switch array layer 25 is configured for 4 switch functions. The control surface 27 has a front surface with control icon indicia corresponding to an array of switch electrodes on its rear surface.

FIG. 3 illustrates a set of control icons to operate the taps in a shower bath.

The switches actuate electrically controlled valves.

The valves may be actuated by touching the “on” icon and either the bath or shower icon. Temperature is controlled by pressing the red and blue icons.

The function of the switch covers is better understood with reference to FIGS. 4 to 7. The switch array consists of an array of printed interdigitated electrodes as shown in a) of FIG. 4. This has 5 switch positions. The same pattern is produced on the back of the cover plates which when mounted to the switch body are separated from the switch body array by a dielectric layer.

By interconnecting the interdigitated electrodes as shown in b) c) d) and e) of FIG. 4 the number of active switches can be reduced.

The four switch panel of FIG. 5 has a pattern as shown in b) of FIG. 4 on the reverse face corresponding to the switch positions. The diagonal interdigitation cancels the switch in the central position.

The three switch panel of FIG. 6 has the pattern shown in c) of FIG. 4 on its reverse face. Each outer pair of electrode arrays are connected to form one switch.

To produce a two panel switch the central electrode array is cancelled by a diagonal as shown in d) of FIG. 4 so that the outer pairs of electrode arrays on the back face correspond with the two switch positions as shown in FIG. 7. A single central switch location can be used for the fully connected array of e) of FIG. 4.

From the above it can be seen that the present invention conserves inventory in that only one switch body is needed to cover 5 different switch panel configurations and the conversion from one configuration to another is achieved by simply changing the cover.

In an alternate form of the invention the inactive electrodes on the back of the cover plate could be omitted.

Using capacitance or proximity sensitive switches in an array gestures such as sweeping the hand from left to right can actuate a mechanism to open an electrically driven door or blinds and gesturing right to left can close them.

FIG. 8 illustrates a cover plate 60 and backing plate 70 with touch and gesture style switches. Sweeping the hand up or down in the gesture field 61 activates the corresponding array 71 to switch on an appliance, such as an air conditioner. The keys 62, 63 (or primary control surfaces) have the same on off function in conjunction with the back electrodes 72, 73. The keys 64, 65 in conjunction with 74, 75 incrementally increase the value of an operational parameter eg: the temperature of an air conditioning unit. The same result can be achieved by sweeping the hand up or down in gesture field 66 to activate the array of electrodes 76 on the back plate to turn the temperature up or down.

With reference to FIG. 9 the tactile switch unit 35 is associated with the cover 30. the icons 31 on the cover 30 actuate the active switches 37 on the switch unit 37. The switch units 36 and 38 have no icons associated with them. The switch units 36 maybe used for identification purposes where the controller responds to the identification code to activate appliances in accordance with the intention of the program. The switch units 38 are not activatable by pressing the icons 31.

In FIG. 10A another tactile switch arrangement is illustrated. FIG. 10B schematically illustrates the active position of the switches when the cover is in place and FIG. 10C shows the switch positions when the cover is in place and one switch icon on the cover is pressed. The cover 40 has icons 41 and 42 which can be pressed to actuate the actuation projections 43 and 46 on the back of the cover 40. Actuation projection 43 engages the switch unit 51 in the back plate 50 when the icon 41 is pressed. Similarly pressing icon 42 causes projection 46 to engage the switch unit 54. When the cover 40 is attached to the back plate projection 45 permanently engages the switch unit 53 so that it is permanently on. There is no projection at position 44 on the back of the cover 40 so that switch unit 52 is permanently inactive. Thus by varying the actuation projections on the back of the cover any switch backplate can be reconfigured by simply changing the cover.

The unit as described with reference to FIG. 10 can be used to convey a code identifying the switch cover and its functions to the preprogrammed controller. The switches 52 and 53 which are set by fixing the cover to the back plate can represent 4 separate logic states the one shown being 0,1. The switch states are read by the control board to identify the cover and to subsequently assign the functionality to the switches 51 and 54 which are operated by touch.

Those skilled in the art will realize that any number of switch positions can be used depending on the capacity of the fixed unit and the corresponding physical size of the switch cover.

1. An automation system for programming appliances having two or more switch units capable of carrying a switch array to control specified appliances, each switch array having a switch cover with actuation icons corresponding to the appliances to be controlled and switch enabling means that only activate the switches corresponding to the actuation icons on said switch cover in which the appliances to be controlled from a switch unit may be varied by changing the switch cover.

2. A panel switch which includes
a) a fixed unit capable of carrying a multiple n of active switches
b) a replaceable cover for the fixed unit able to carry up to n active contact closure positions
c) where in the covers only carry as many active positions as is desired so that the number of active switches on a fixed unit and the number of actuation positions can be changed by changing the cover.

3. A cover for the panel switch as defined in claim 2 which carries icons or contact positions on the front and switch actuation means on the back corresponding to said icons.

4. A cover as claimed in claim 3 wherein the switches are tactile switches

5. A switch panel which includes
a. an electronic control circuit and an associated switch array for capacitative or charge transfer switches to activate appliances in communication with said control circuit
b. a control array bearing electrodes to complete a predetermined number of said switches on said switch array
c. said control array being associated with a cover member carrying on its face surface icon indicia corresponding to the appliances to be actuated from the panel switch.

6. A switch cover for use in the panel switch of claim 4 which includes icons corresponding to the appliances to be actuated by said switches and switch actuation electrodes corresponding to said icons.
